(19) United States
(12) Patent Application Publication
(10) Pub. No.: US 2003/0225470 A1
(43) Pub. Date: Dec. 4, 2003

(54) Method and system for making a product

(76) Inventors: John Savvas Demetriou, Dexter, MI (US); Michael Wrublewski, Northville, MI (US); Alan McDonald, West Bloomfield, MI (US); Walter Fredereick Bielski, Plymouth, MI (US); Richard Louis Hamilton, Novi, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/354,513

(22) Filed: Jan. 30, 2003

Related U.S. Application Data
(60) Provisional application No. 60/353,068, filed on Jan. 30, 2002.

(51) Int. Cl. G06F 19/00

(52) U.S. Cl. 700/100

(57) ABSTRACT

A computer-implemented system for product development. The system includes a number of tasks that define product development. The tasks are related according to finish-to-start relationships.

### CROSS-REFERENCE TO RELATED APPLICATIONS

This application claims the benefit of U.S. Provisional application Serial No. 60/353,068, filed Jan. 30, 2002.

### BACKGROUND OF THE INVENTION

1. Field of the Invention

The present invention relates to methods and systems for product development.

2. Background Art

Product development refers to the life cycle of tasks required to manufacture a product by a specified due date. The tasks can encompass any number of performance criterion and due dates.

Typically, product development methods and system have been used to interrelate each task to at least one other task. The interrelation of one task to another task is done with difficulty.

The method shown in FIG. 1 provides at least one example of the difficulties with related task based methods and systems. As shown, a task #1 and a task #2 are related with a finish-to-finish relationship and task #2 and task #3 are related with a start-to-start relationship. As is common with product development, the time to complete one of the tasks may change.

This change in completion time can present implementation difficulties, as shown in FIG. 2. The time to complete task #2 has decreased due to, for example, increased resource allocation or method improvements. It is, however, fully understood that any number of events can occur during the life cycle of product development which influence completion time.

Decreasing the time to complete task #2 would seem to be an improvement, but when such an related method is used, task #4 and those that follow are negatively affect by the improvement.

More specifically, in the finish-to-finish relationship of task #1 and task #2, task #2 cannot finish until task #1 finishes. If the time to complete task #2 is decreased, then the start of task #2 is correspondingly delayed until task #2 can finish after task #1 finishes.

In the start-to-start relationship of task #2 and task #3, task #3 cannot start until task #2 has started. Consequently, assuming the time to complete task #3 has not change, the start of task #3 is delayed until task #2 has started. The completion of task #3 is thus delayed beyond the original completion date of task #3. Accordingly, by decreasing the time to complete task #2, the completion of task #3 was delayed. As all the tasks are related, task #4 and those that follow are also delayed and negatively affected by the improvement.

### SUMMARY OF THE INVENTION

One aspect of the present invention relates to a method for making a product. The method comprises determining a number of tasks to complete for making the product. Each task includes a start date and a due date that together define a task completion time as a time interval from the start date to the due date. The method further comprises arranging the tasks for completion according to finish-to-start relationships. The finish-to-start relationship of the tasks allow for the completion time of a predeceasing task to be decreased without increasing the completion time of a subsequent related task. The method yet further comprises recording a product development schedule from the arranged tasks and performing the number of tasks according to the schedule to make the product. The performance of a subsequent task starts only after the related predecessing task is completed.

Another aspect of the present invention relates to a system for making a product. The system comprises a number of tasks to complete for making the product. Each task includes a start date and a due date that together define a task completion time as a time interval from the start date to the due date. The tasks have finish-to-start relationships to allow for the completion time of a predecessing task to be decreased without increasing the completion time of a subsequent related task. The system further comprises a computer for storing the number of tasks in the form of a product development schedule based on the finish-to-start relationship of the tasks for use in performing the number of tasks according to the schedule to make the product. The performance of a subsequent task starts only after the related predecessing task is completed.

Yet another aspect of the present invention relates to a computer-implemented system for making a product. The system comprises a computer-readable medium having a number of product development tasks to complete for making the product. Each task includes a due date, a deliverable description, and a metric description. The tasks are related according to finish-to-start relationships based on the due dates such that performance of a subsequent task starts only after a related predecessing task is completed. The system further comprises at least one media viewer configured to visually display each task. Each displayed task is selectable for inputting upon completion of the task a deliverable and a metric for the corresponding deliverable description and metric description. The inputted deliverable and metric are transmitted to the computer-readable medium for use in monitoring the making of the product.

### BRIEF DESCRIPTION OF THE DRAWINGS

FIG. 1 illustrates a product development method in accordance with the prior art;

FIG. 2 illustrates a difficulty with the product development method of the prior art;

FIG. 3 illustrates a product development method in accordance with the present invention;

FIG. 4 illustrates a finish-to-start relationship of the product development method in accordance with the present invention;

FIG. 5 illustrates a system for implementing the method shown in FIG. 3 in accordance with the present invention;

FIG. 6 illustrates a task in accordance with the present invention;

FIG. 7 illustrates a flowchart viewer in accordance with the present invention;

FIG. 8 illustrates a first module in accordance with the present invention;

FIG. 9 illustrates a second module in accordance with the present invention;

FIG. 10 illustrates a third module in accordance with the present invention;

FIG. 11 illustrates a fourth module in accordance with the present invention;

FIG. 12 illustrates a fifth module in accordance with the present invention;

FIG. 13 illustrates a sixth module in accordance with the present invention;

FIG. 14 illustrates a seventh module in accordance with the present invention;

FIG. 15 illustrates an eighth module in accordance with the present invention;

FIG. 16 illustrates a ninth module in accordance with the present invention;

FIG. 17 illustrates a tenth module in accordance with the present invention;

FIG. 18 illustrates a file-folder media viewer in accordance with the present invention; and

FIG. 19 illustrates a deliverables media viewer in accordance with the present invention.

### DETAILED DESCRIPTION OF THE PREFERRED EMBODIMENT(S)

FIG. 3 illustrates a computer-implemented method 10 according to one aspect of the present invention. The system breaks the life cycle of product development down to a number of tasks 12 related with finish-to-start relationships. The tasks 12 are arranged according a product development schedule 13 based on a finish-to-start relationship for the tasks 12. The method 10 can be used to develop virtually any product. The method 10 is particularly advantageous to the automotive industry.

In the automotive industry, the life cycle for product development of a vehicle is rather lengthy. The method 10 can conduct and monitor the product development of the vehicle to insure it is ready for production at some future point that is typically years away. The present invention is suitable for these robust types of product development. In addition, the present invention is suitable to refresh or make other minor changes to an already developed product. For example, it may be desirable to change a relatively minor item on the already developed vehicle, but it would be undesirable to redo the entire product development method used to develop the vehicle. Rather, the present invention provides a system that can be used to develop such a minor product without implementing the entire product development method for the vehicle.

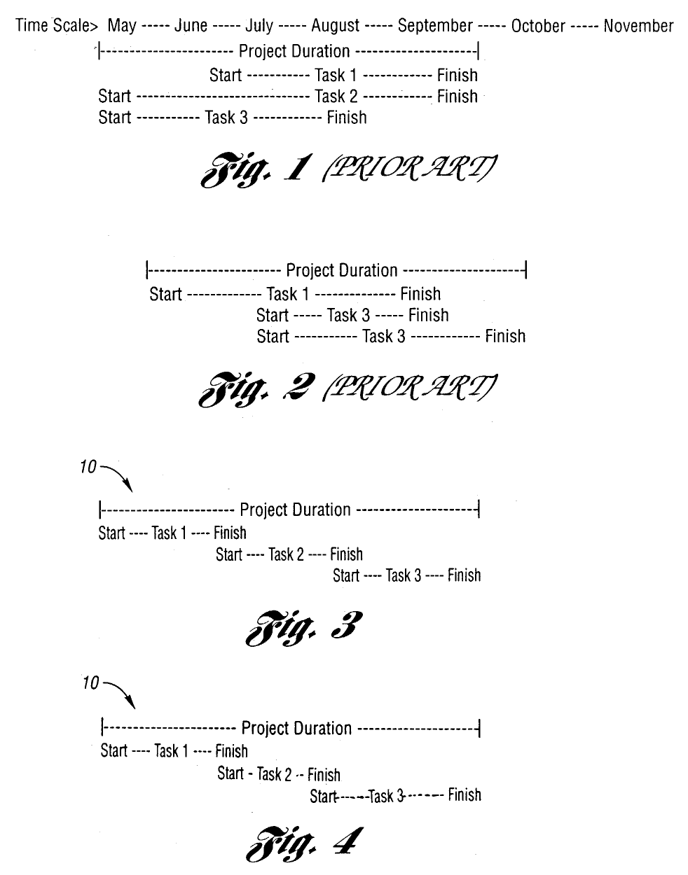

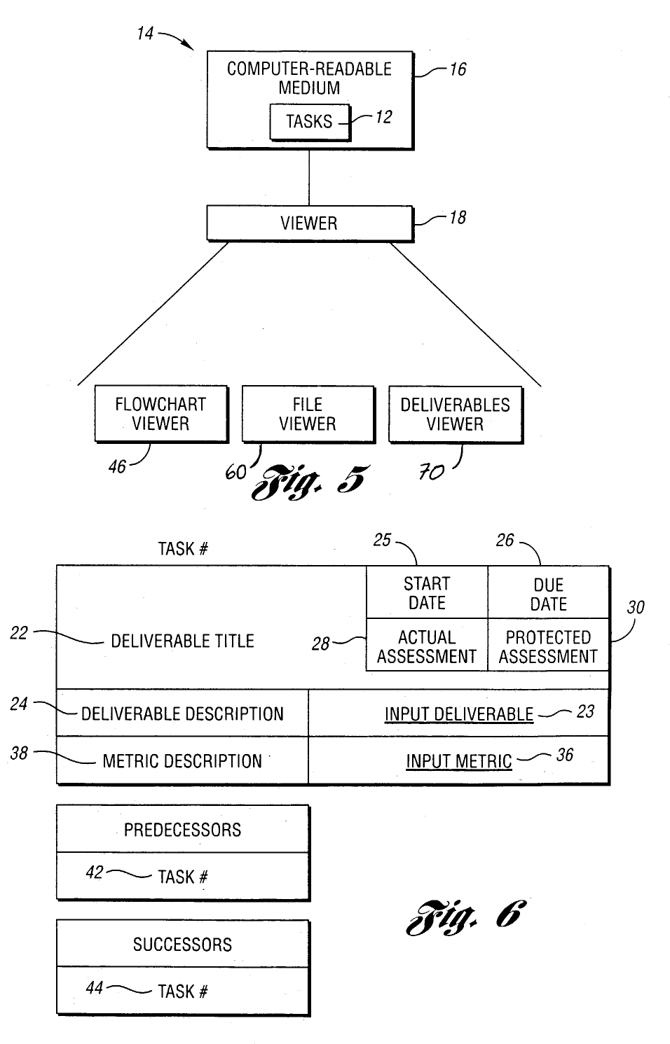

As described in the background section and illustrated in FIGS. 1 and 2, the interrelation of task 12 within the product development method plays a vital role in product development. More specifically, the interrelation of task can negatively affect subsequent task. As described, the improvement in the time to complete one task can negatively affect the finish time of another subsequent task.

The present invention includes the ability to make improvements to tasks 12 without negatively affecting the finish time of subsequent tasks. The present invention is configured with only finish-to-start interrelations of the tasks. Accordingly, the present invention can increase the time to complete the preceding task and not adversely effect the finish date of the subsequent task.

As shown in FIG. 3, task #1 and task #2 have a finish-to-start relationship and task #2 and task #3 have a finish-to-start relationship. Unlike the relationship displayed in FIGS. 1-2, the relationship shown in FIG. 3 is not adversely affected when the time to complete task #2 is decreased.

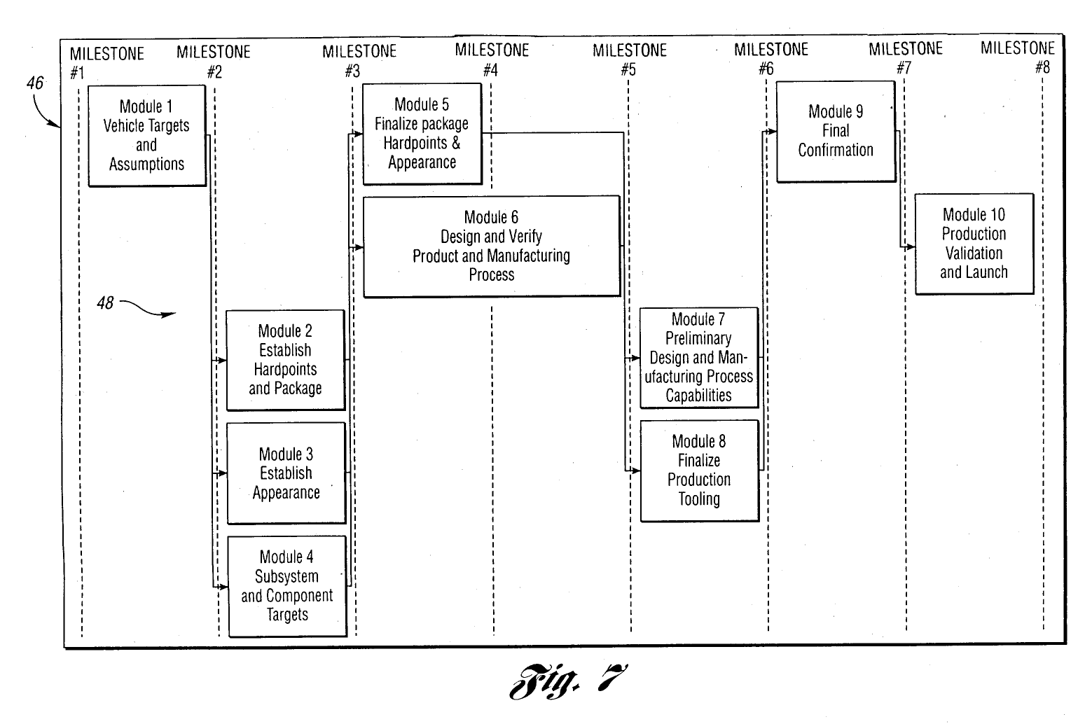

The finish-to-start interrelation of task #1 and #2 requires task #2 to begin after task #1 is finished. Likewise, the finish-to-start interrelation of task #2 and task #3 requires task #3 to begin after task is finished. Accordingly, if the time to complete task #2 is decreased, the finish date of task #3 is not adversely effected. To the contrary, as shown in FIG. 4, the finish date of task #3 is improved and occurs at an earlier date.

Turning to FIG. 5, a system 14 comprising a computer-readable medium 16 and at least one media viewer 18 can be used to implement the method 10. The computer-readable medium 16 interrelates the tasks 12 with the finish-to-start relationships that define product development. The viewer 18 is used to access the computer-readable medium 16 and to visually present the tasks 12 in a schedule type form to a product developer. The viewer 18 can be a web-base medium, such as a web page, that can access the computer-readable medium from remote locations through the worldwide web or other system. The viewer 18 can also transmit and receive information to and from the computer-readable medium 16.

The viewer 18 is configured to visually present the tasks 12 to the product developer. Using the viewer 18, the product developer can view the task 12 in chronological order. Based on the order of each task 12, the product developer understands the tasks 12 that need to be completed for the product to be completed on time.

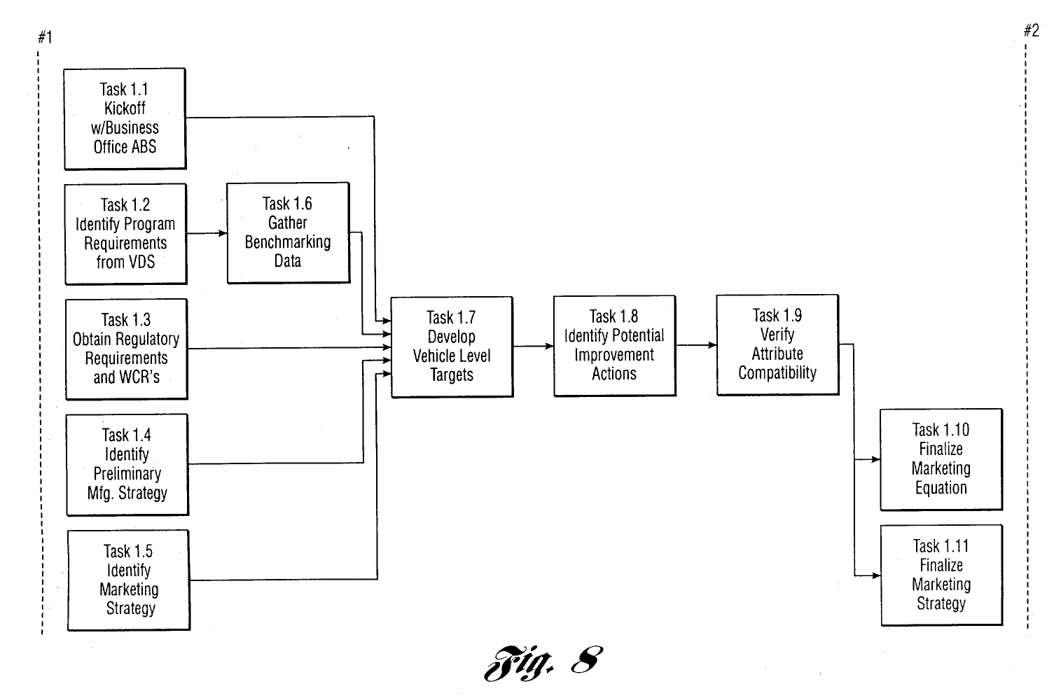

FIG. 6 illustrates the presentation of a task 12 to the product developer in accordance with one aspect of the present invention. Each task 12 includes one or more deliverable titles 22 and a link for inputting a deliverable 23. Each deliverable title 22 relates to the substance of the task that the product developer is to complete. The deliverable 23 includes a deliverable description 24. The deliverable description 24 explains with more detail what the product developer is to complete.

Each task 12 includes a start date 25 and a due date 26. The start date 25 relates to the time for beginning performance to complete the task. The due date relates the deliverable 23 to a chronological point in the product development life cycle. The task 12 includes a link for the product developer to input an actual assessment 28 rating and a predicted assessment rating 30. The inputted ratings are transmitted to the computer-readable medium 16 for use in determining whether the deliverable 23 will be completed by the specified due date 26. The ratings can be used to adjust the start date 25 and the due date 26 of each task.

The actual assessment rating 28 reflects the product developers current progress in completing the task. The ratings can be yellow Y, red R, and green G. Green reflects that the product developer is on schedule to complete the task. Yellow reflects the product developer is not on schedule to complete the task, but has a plan to complete the task on time. Red R reflects the product developer is not on schedule to complete the task and has no plan to complete the task on time.

The predicted assessment 30 rating reflects whether the product developer is likely to complete the task when due. The ratings are the same yellow Y, red R, and green G. The predicted assessments are used to cover the situation where the task is currently on time but the product developer knows of a pending problem that will delay completion.

For example, the current task may not be starting for another week, but the predecessing task has a problem and is not scheduled to be completed for an additional two weeks. Since the current task cannot start until the predecessing task is completed, the current task cannot begin until one week after it was scheduled to begin. The actual assessment reflects that the current task is currently on time, as it was not due to start for another week, but the predicted assessment reflects that the current task will be late due to the predeceasing task being one week late. In this case, the actual assessment is green G and the predicted assessment is red R, unless there is a plan to compensate for the delayed start and finish on time in which case the rating is yellow Y.

Once the subject matter reference to in a deliverable title 22 is completed, the product developer inputs the deliverable 34 using a deliverable link. The inputted deliverable 22 is transmitted to the computer-readable medium 16. In addition to inputting the deliverable 34, the product developer inputs a metric 36 using the metric link. The metric 36 is a response to a corresponding metric description 38. The metric description 38 specifies a standard of measurement for the deliverable, and the metric is the product developers response as to how closely the deliverable meets the standard of measurement. The inputted metric 36 is transmitted to the computer-readable medium.

Accordingly, for each task 12, the product developer inputs the actual assessment rating 28, the predicted assessment rating 30, the deliverable 34, and the metric 36. The inputted items are transmitted to the computer-readable medium 16. Based on the inputted items, a product development clerk or other person who has access to the computer-readable medium can adjust the start dates 25 and the due dates 26. In addition, if so authorized, the product developer can use the medium viewer 18 to adjust the due dates 26.

As each of the tasks 12 are related with finish-to-start relationships, any change to the due date 26 of one task 12 does not necessarily affect the due date of the subsequent tasks. Rather, the time to complete the subsequent tasks is decreased unless the clerk or product developer makes a adjustments to the start dates 25 and the due dates 26 of the subsequent tasks. The computer-readable medium could, however, be configured to automatically changes the start dates 25 and the due dates 26 according to the changes in the predecessing tasks.

As also shown in FIG. 6, links to the predeceasing 42 and subsequent tasks 44 are provided. These links can be used to view the other tasks. The links can also be used to assist in determining the actual assessment rating 28 and the predicted assessment rating.

FIG. 7 illustrates a work-flow medium viewer 46 according to one aspect of the present invention. The work-flow viewer 46 graphically groups related task 12 within a number of modules 48. The modules 48 correspond with the tasks 12 having due dates 26 that occur within a number of product development milestones, KO, SI, DA, ST, AR, CC, LR, DD. Each of the modules 48 are selectable to view the tasks 12 group therein. Each of the tasks 12 are then selectable to input the data shown in FIG. 6.

The work-flow medium viewer 46 provides a workflow sequence for product development. Each of the modules 48, like the tasks 12 group therein, are related according to finish-to-start relationships. The modules 48 that can be used in accordance with one aspect of the present invention include a first module #1 for establishing vehicle targets and assumptions, a second module #2 for establishing hardpoints and packaging, a third module #3 for establishing appearance, a fourth module #4 for establishing subsystem and component targets, a fifth module #5 for finalizing package hardpoints and appearance, a sixth module #6 for design and verification of product and manufacturing methods, a seventh module #7 for preliminary design and manufacturing method confirmation, an eighth module #8 for finalizing production tooling, a ninth module #9 for final confirmation, and a tenth module #10 for production validation and launch.

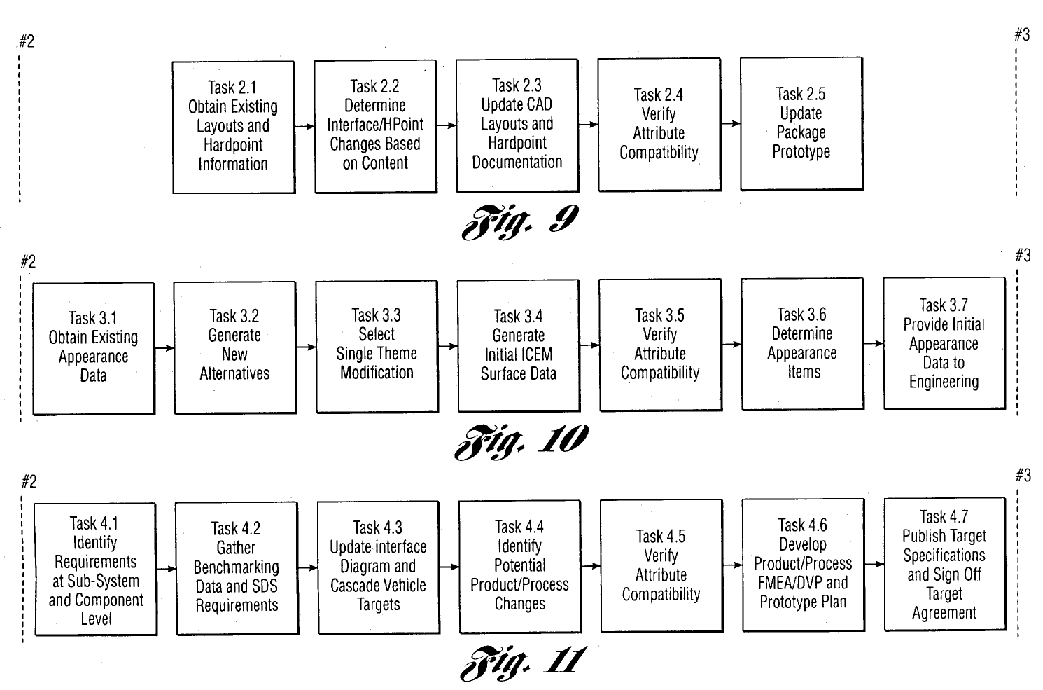

FIG. 8 illustrates the tasks 12 grouped within module #1 for establishing vehicle targets and assumptions. The purpose of module #1 is to identify program wants and needs from three sources: the customer, the corporation and all regulatory bodies that have jurisdiction over the product. Once the key wants and needs have been identified, actions to support those desires are developed. This module considers the Available Business Structure (ABS) to ensure the actions are containable within the programs resources. This module also captures the attribute target verification testing needed to confirm that the targets have been met and that they are balanced.

Task 1.1 relates to Kickoff (KO) with Business Office ABS. This task includes a program Kickoff one-pager including the Affordable Business Structure to be developed by the Vehicle Center Business Office and filed for review by the appropriate Company committee.

Task 1.2 relates to Identify Program Requirements from Vehicle Design Specification (VDS). This task includes reviewing and selecting target requirements for each of the VDS Attributes. In addition, this task includes translating customer wants into functional characteristics and engineering requirements (i.e., engineering interpretations of attribute performance criteria). An example would be 0 to 60 MPH times for “performance”. Information sources include WCR, VDS, and SDS.

Task 1.3 relates to obtaining Regulatory Requirements and World Corporate Requirements (WCR). This task includes reviewing the regulatory and homologation information for relevant requirements to your program. This is driven by key markets as identified by the business office assumptions and also determines which revision level of WCRs the program plans to meet and to identify those requirements that will carry “grandfathered” deviations.

Task 1.4 relates to identifying a Preliminary Manufacturing Strategy. This task includes providing: 1) a detailed Manufacturing Plan including reusability targets, capacity, strategy elements and launch plan, (2) integration of full service tool suppliers, (3) simultaneous engineering, (4) manufacturing assembly/process feasibility, and (5) compatibility between the manufacturing/assembly method and the Affordable Business Structure.

Task 1.5 relates to identifying a Marketing Strategy. This task includes Global Product Marketing reviews of the Primary Brand and carryover Nameplate Brand Positioning and Profiler for each key market relative to competition. It is reviewed consented to by the Program Team and becomes the program's Initial Brand Profiler(s). The key markets will be those for which detailed customer, brand, lead definition of requirements will be developed. Relevancy to target customers through the annual analyzing and diagnosis method of brand is required.

Task 1.6 relates to gathering Benchmarking Data. This task includes reviewing identified competitive vehicles, and attributing characteristics.

Task 1.7 relates to developing Vehicle Level Targets. This task includes developing vehicle level point targets for the identified Attributes and their corresponding VDS metrics.

Task 1.8 relates to identifying potential improvement actions. This task includes identify potential product actions that may reduce or eliminate identified attribute gaps. Potential product actions include commodity or technology based items that can be adopted by the program to reduce or eliminate the identified gaps.

Task 1.9 relates to verifying Attribute Compatibility. This task includes assessing action compatibility across all attributes including the ABS, as it is reconciled with the Vehicle Operation (VO) Clearinghouse. This step is a decision point. If the program is incompatible, the product developer is to modify either assumptions or targets and return to step 1.8. At this point, the program should also have a compatible sourcing strategy, which identifies any sourcing changes and a quality plan.

Task 1.10 relates to finalizing a Marketing Equation. This task includes Global Product Marketing and the Vehicle Center (VC) Worldwide Revenue (WWR) Managers obtaining commitments to the market equation elements for the key markets.

Task 1.11 relates to finalizing Manufacturing Strategy. This task includes updating the preliminary manufacturing strategy based on the results of the attribute compatibility.

FIG. 9 illustrates the tasks grouped within module #2 for establishing hardpoints and package. This module is performed when there are changes to the mechanical package, and/or to the hardpoints that constrain appearance and affect the published dimensions of the vehicle contained in the vehicle specification. The primary output of this module is achieved by making sure that the existing vehicle package and hardpoints are modified to reflect the desired actions determined in module #1. Computer Aided Design (CAD) constraints are determined and provided for any appearance development work, and component design work.

Task 2.1 relates to obtaining Existing Layouts and Hardpoint Information. This task includes obtaining the starting information (package layouts, hardpoint data) from the primary vehicle for modification.

Task 2.2 relates to Determining Interfaces/Hardpoint Changes Based on Content. This includes using the information from module #1 while working with the groups performing modules #3 and #4, determine the areas of change in the package/hardpoint information.

Task 2.3 relates to update CAD Layouts and Hardpoint Documentation. This includes generating new CAD layouts and hardpoint documentation that reflect the modifications to the vehicle package from the desired changes. At this time, the information should reflect either constraints based on envelopes or targeted values. This information will be updated and finalized at a later point in time, when component designs are completed.

Task 2.4 relates to verifying Attribute Compatibility. This task includes verifying that the desired change from module #1, and requirements developed concurrently in modules #3 and #4 are compatible from a spatial perspective. If all is not compatible with the other corresponding tasks in this module, reiterate the method until compatibility is achieved or change the due dates.

Task 2.5 relates to updating Package Bucks. This task includes the digital buck is updated to reflect the new data if available or required for evaluation. The physical bucks are updated to reflect the new data.

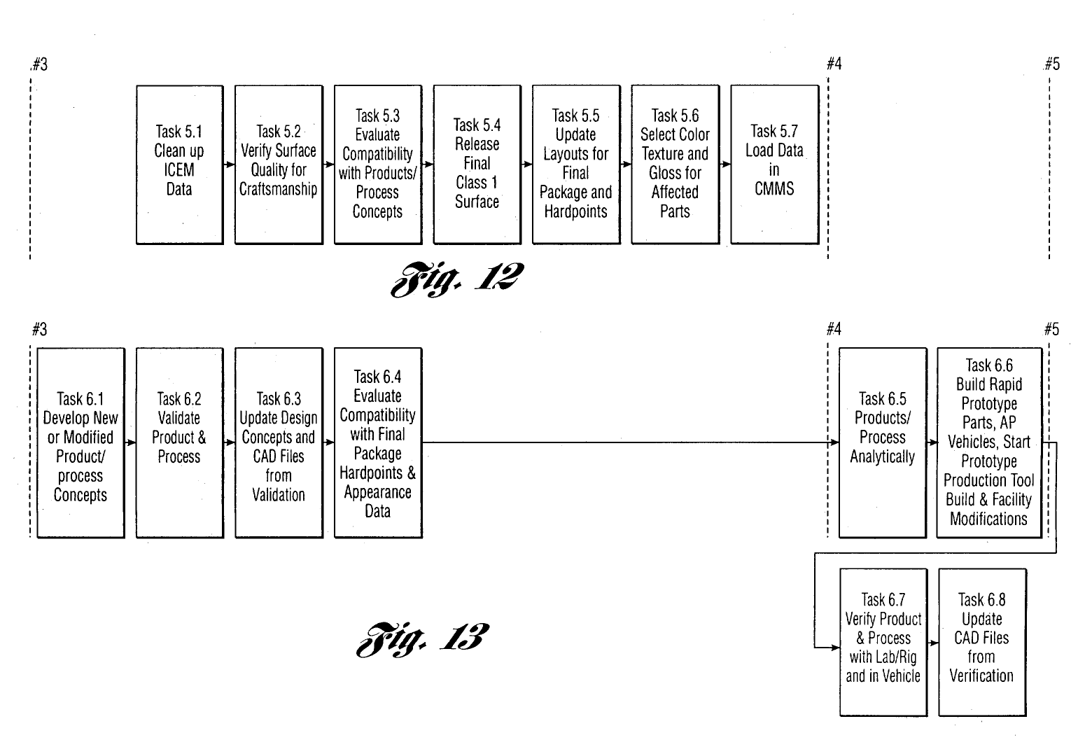

FIG. 10 illustrates the tasks grouped within module #3 for Establishing Appearance. This module is performed when there are changes to appearance items as either surface modifications or as changes to color, texture or gloss of an appearance item. In some cases, most of this module can be skipped even if the appearance is changing—such as when the program direction is predetermined to be a change to a different, existing seat fabric (then only CMIMS data needs updating). Component appearance modifications are generated consistent with the inputs from module #1, the package/hardpoint and target development in modules #2 and #4. The primary output of this module is achieved by insuring that all data, both surface data and appearance item details, in interior color database are available when required and are compatible with all other requirements. Exterior surface database is generated in this module to support modifications to the Reference/Data Control models for final appearance/craftsmanship review and signoff.

Task 3.1 relates to obtaining Existing Appearance Data. This task includes obtaining the existing product information in the areas that are to be changed.

Task 3.2 relates to generating New Alternatives. This task includes generating the new alternatives for the appearance change, either in Computer Aided Industrial Design (CAID) tools, clay models, or on fabric/color sample mockups.

Task 3.3 relates to selecting Single Theme Modification. This task includes selecting one theme or modification for final development.

Task 3.4 relates to generating Initial ICEM Surface Data. This task is included if surface is changing, generate a surface model that is consistent with all requirements, to be used for final class 1 surface development.

Task 3.5 relates to verifying Attribute Compatibility. This task includes verifying that all appearance related information is compatible with all program requirements. If all is not compatible with the other corresponding tasks in this module, reiterate the method until compatibility is achieved or change the due dates.

Task 3.6 relates to determining Appearance Items. This task includes determining the affected appearance items note: appearance items refers to the individual items that collectively make up an end item—a door trim panel may have as many as 15 appearance items in the one part number. This step identifies all of the appearance items within the affected end items.

Task 3.7 relates to providing initial appearance to Engineering. This task includes transferring any data to engineering for final development and incorporation in CAD files.

FIG. 11 illustrates the tasks grouped within module #4 for Subsystem and Component Targets. The purpose of this module is to cascade the established vehicle targets (from Module #1) to the various subsystems of the vehicle. This module also captures the attribute target verification testing needed to confirm the targets have been met and that they are balanced. The module ends with the signing of Target Agreements with suppliers.

Task 4.1 relates to identifying Requirements at the Subsystem and Component Level. This task includes identification of requirements against all applicable Attributes (Customer, Corporate, and Regulatory Requirements).

Task 4.2 relates to gathering Benchmarking Data and Subsystem Design Specification (SDS) Requirements. This task includes reviewing identified competitive vehicles, and the comparator vehicle for attribute characteristics at the subsystem/component level.

Task 4.3 includes updating Interface Diagram and Cascade Vehicle Targets. This task includes modifying any existing interface diagrams to reflect anticipated changes. These diagrams reflect the functional inputs/outputs to any subsystem/component and developing subsystem and component point targets for the identified Attributes and their corresponding requirements.

Task 4.4 relates to identifying Potential Product/Process Changes. This task includes identifying potential product or method actions that may reduce or eliminate identified Attribute metric gaps at the subsystem/component level.

Task 4.5 relates to verifying Attribute Compatibility. This task includes assessing compatibility across all attributes including the ABS and Manufacturing. If all is not compatible with the other corresponding tasks in this module, reiterate the method until compatibility is achieved or change the due dates.

Task 4.6 relates to developing Product/Process Failure Mode and Effect Analysis (FMEA)/Design Verification Plan (DVP) and Prototype Plan. This task includes conducting a fail mode and effect analysis to increase the probability that potential failure modes and their effects on system/vehicle operation have been considered in the design method. In addition, this table includes using attribute compatible targets and FMEA data construct a design verification plan and utilizing the consolidated design verification plans to determine the program prototype plan and CP tunable items list.

Task 4.7 relates to publishing Target Specification and Signoff Target Agreements. This task includes obtaining a program specification with targets and DVPs that are combined with Statements of Work and signed off as part of the Target Agreement Method.

In addition, this task includes producing purchase issues and purchase orders using the signed off target agreements for both material and tooling to support prototype and production builds. It also includes program requirements with targets and DVPs that constitute the targets specification. Worldwide Engineering Release (WER) file setup is completed in conjunction with the targets method.

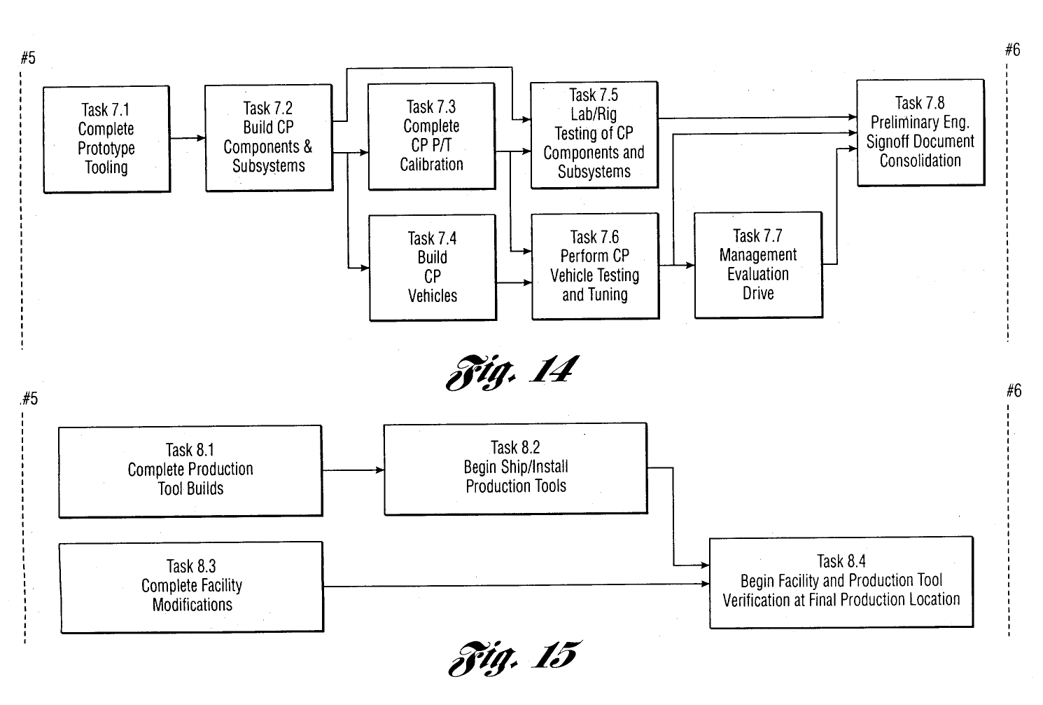

FIG. 12 illustrates the tasks grouped in this module #5 for finalizing package, hardpoints, and Appearance. This module is performed when there are changes to the mechanical package, hardpoints or appearance in modules #2 and #3. The goal of this module is to finalize the Class 1 surface through the use of existing Reference/Data Control models or snapshot milled models (if a Reference/Data Control model does not yet exist for the product). The module covers release of the final CMIMS data and the update or completion of the package layouts based on the final component CAD data. This module also verifies that any Class 1 surface modifications meet craftsmanship standards prior to release of final class 1 surface to engineering.

Task 5.1 relates to cleaning up ICEM Data. This task includes the ICEM surface data is cleaned up and reviewer electronically for acceptability prior to physical prove-out.

Task 5.2 relates to verifying Surface Quality for Craftsmanship. This task includes updating the required components on the existing Reference/Data Control model from the existing product (if available—use is being phased in. Otherwise update cube models). This method results in a signed off Class 1 surface as a final product, as well as an “appearance master model” used for future comparison (model is 100% representative of surface data).

Task 5.3 relates to evaluating Compatibility with Product/Process Design Concepts. This task includes reviewing the final class 1 surface with the updated design concepts CAD files to assure compatibility. If all is not compatible with the other corresponding tasks in this module, reiterate the method until compatibility is achieved or change the due dates.

Task 5.4 relates to releasing Final Class 1 Surface. This task includes finalizing a class 1 surface that is transferred to engineering for incorporation in CAD for final release.

Task 5.5 relates to updating Layouts for Final Package and hardpoints. This task includes packaging layouts and hardpoints updated to reflect the final status based on final surface and final component CAD data.

Task 5.6 relates to selecting Color, Texture, and Gloss for Affected Parts. This task includes determining the detailed information for all appearance items (note: appearance items have already been identified, this just determines the data for each appearance item).

Task 5.7 relates to loading data in CMIMS. This task includes loading all appearance item information in CMIMS for supplier use.

FIG. 13 illustrates the tasks grouped within module #6 for designing and Verifying Product and Manufacturing Method. Once a set of subsystem and component specifications have been completed the design engineers Program Module Teams (PMT) are responsible for creating designs to meet those specifications. Engineers are expected to use the robust engineering methodology to optimize component and subsystem designs. The designs should be compatible with the hardpoints, package and appearance direction selected by the team. The design engineer is responsible for delivering the product as well as the manufacturing method design necessary in the production of a given vehicle. The product design includes both end item or subsystem hardware and related software (i.e., powertrain calibration). The manufacturing method includes any necessary production and/or prototype tooling and facility modifications. All product and method designs are verified utilizing the Design Verification Plan (DVP) portion of the specification created in module #4. The objective is to complete verification with enough confidence in the design to support a final engineering release of the data for a confirmation prototype (CP) build at the final production facility utilizing 100% design intent parts.

Task 6.1 relates to developing New or Modified Product/Process Concepts. This task includes developing a new or modified product, manufacturing method or calibration designs to achieve the subsystem and component requirements. The design must be consistent with the program package, hardpoints and appearance assumptions data.

Task 6.2 relates to validating Product/Process. This task includes performing analytical, lab/rig and vehicle experimentation with the preliminary design alternatives to determine the appropriate design direction based the design requirements.

Task 6.3 relates to updating Design Concepts and CAD Files from Validation. This task includes solid model CAD files that are updated to reflect the design direction achieved through the validation method. The updates include all relevant geometry information necessary to meet form, fit, and function requirements including manufacturing/assembly and compatibility with interfacing parts and systems. The best available class I surface data is reflected in the CAD files.

Task 6.4 relates to evaluating Compatibility with Final Package, Hardpoints and Appearance Data. This task includes reviewing the updated CAD files from the validation method with the package, hardpoints and appearance data to assure compatibility. If all is not compatible with the other corresponding tasks in this module, reiterate the method until compatibility is achieved or change the due dates.

Task 6.5 relates to verifying Product/Process Analytically. This task includes performing analytical experimentation on the product/process design to determine if it has met, to an acceptable level, the component, subsystem and vehicle specifications.

Task 6.6 relates to building Rapid Prototype Parts, Attribute Prototype Vehicles, Start Prototype (CP)/Production Tool Builds and Facility Modifications. This task includes utilizing the updated design data, fabricate prototype components utilizing rapid prototype techniques to support design verification. In addition, this task also includes fabricating any necessary attribute prototype vehicles utilizing non-batch production techniques (i.e., hoist/stationary buildup) with target intent, bridging or rapid prototype design intent parts. This task further includes proceeding to construction of needed prototype tooling to support the CP build and begin construction of the production tools. Tooling design will occur simultaneously with tooling construction and product verification. Continued product update information will be provided utilizing the phase data notification method until final engineering release at <PR>. In addition, this task also includes facilitating modifications required to support product/process design changes that include the final assembly building/facility, material handling systems, quality control and assembly tools.

Task 6.7 relates to verifying Product/Process with Lab/Rig and in Vehicle. This task includes performing lab/rig and vehicle experimentation on the product/process design to determine if it has met, to an acceptable level, the component, subsystem and vehicle specifications. In addition, this task also includes tooling verification that includes tryouts and the fabrication of prototype components.

Task 6.8 relates to updating Designs and CAD Files from Verification. This task includes solid model CAD files that are updated to reflect the design direction achieved through the verification method. The updates include all relevant geometry information necessary to meet form, fit, and function requirements including manufacturing/assembly and compatibility with interfacing parts and systems. The class I surface data is reflected in the CAD files. Manufacturing is informed that this is the final engineering release of the design.

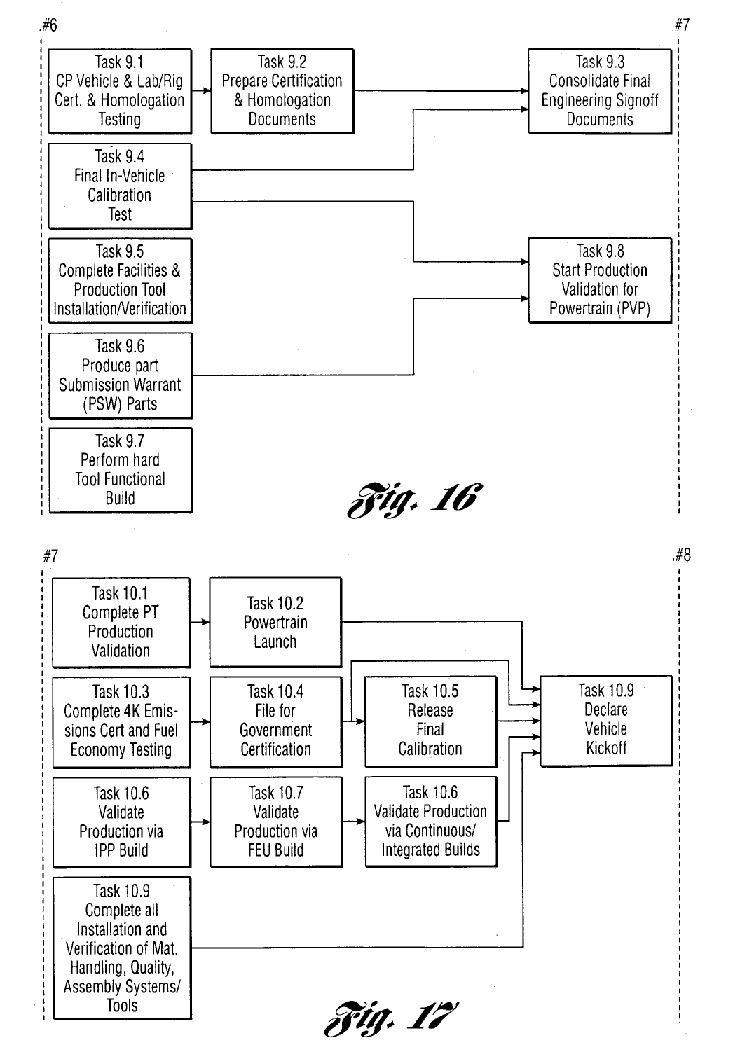

FIG. 14 illustrates the tasks grouped within module #7 for Preliminary Design and Manufacturing Method Confirmation. This task is performed after the final engineering release of data to the manufacturing source (suppliers or internal), components and subsystems are fabricated to support the confirmation prototype (CP) vehicle build. In addition, calibration development and component/subsystem key life testing are performed to support the CP vehicle testing and tuning and eventually the preliminary engineering sign off. The objective is to gather enough confirmation data through vehicle, subsystem, component testing and management evaluation to sign off the vehicle design (preliminary) and to proceed to a hard tool functional build and final engineering sign off.

Task 7.1 relates to Confirmation Prototype (CP) Tooling. This task includes completing the construction of the prototype (CP) tools, shipping and installing them at the final manufacturing location. In addition, this task also includes completing the prototype (CP) tooling verification method with a tryout at the final manufacturing site.

Task 7.2 relates to building CP Components & Subsystems. This task includes using prototype tooling (or production tooling if available) and methods, authorize production of parts to support the first confirmation prototype build In-Plant-Date (IPD). In addition, this task also includes production representative parts that will be manufactured based on the latest product/release level information defining the end items.

Task 7.3 relates to completing Confirmation Prototype and Powertrain Calibration. This task includes first phasing of physical testing to initiate dynamometer calibration method on prototype hardware to verify targets and to develop an initial P/T EEC calibration for vehicle testing. This method step can begin earlier if powertrain components are available pre-PR as rapid prototypes.

Task 7.4 relates to building CP Vehicles. This task includes building the confirmation prototype vehicles at the final production location.

Task 7.5 relates to Lab/Rig Testing of CP Components and Subsystems. This task includes setting up lab/rig confirmation test for the CP components and subsystems. The tests are set up utilizing the appropriate Design Verification Methods as outlined in the Subsystem Design Specifications or Component Design Specifications created in module #4.

Task 7.6 relates to performing CP Vehicle Testing and Tuning. This task includes setting up and running tests on CP vehicles utilizing appropriate design verification methods as outlined in the Vehicle Design Specification (VDS), System/Subsystem Design Specifications (SDSs) and Component Design Specifications (CDSs) created in modules #1 and #4. In addition, this task also includes both on road testing and lab/rig testing that can be performed, including durability. The vehicle tuning and powertrain calibration tests are set up with the same Confirmation Prototypes (CP) vehicles. Components for tuning have been designed and released based on a Tunable Items List.

Task 7.7 relates to managing Evaluation Drive. This task includes the management evaluation drive that assessing real world status versus the vehicle attribute objectives. At a minimum, drive evaluation participants should include the Vehicle Line Director, the Chief Program Engineer (CPE), the Project Manager, the Marketing Plans and Brand Development Manager, the New Model Programs Manager, the Functional Design Managers, and the Powertrain Project Manager. Participation from other affected activities is at the discretion of the CPE. The drive evaluation ratings, combined with similar data from the expert drive evaluators, should be used to develop the assessments on program status versus objectives.

Task 7.8 relates to Preliminary Engineering Sign off Document Consolidation & Marketing Launch. This task includes the preliminary engineering sign off as an event that assesses the vehicle program status at change cutoff and all documentation is prepared to provide appropriate report on the status of the deliverables. A detailed marketing launch plan is also released at this same point in time that details timing and plans/strategies for public affairs, fleet, advertising, training and other marketing activities.

FIG. 15 illustrates the tasks grouped within module #8 for finalizing Production Tooling. This module includes utilizing information provided via the final engineering release the manufacturing/assembly activity (suppliers and internal) finalize the construction, shipping and installation of the production tools. Facility modifications are completed and production tool and facility verification at the final production facility is initiated. The objective is to have the facilities and production tooling in place at the final production location to support a hard tool functional build.

Task 8.1 relates to completing Production Tool Builds. This task includes completing building of all production tools and equipment (new and/or modified items) consistent with the program specific requirements per the approved tool and equipment designs and complying to Ford tooling standards and any applicable laws. The build phase is to meet the cost and timing agreements identified in the signed target agreements and purchase orders generated in module #4. Production tools and equipment that do not require a supplier tool tryout, may be built and/or assembled at the final production location based on local plant agreements. The build/assembly location agreements are to defined in the purchase order.

Task 8.2 relates to beginning Ship/Install Production Tools. This task includes following design and build (and supplier try-out, if required) production tooling and equipment will be shipped to the respective manufacturing location(s) in support of final production installation timing. Shipping requirements such as method(s) of transportation, duties and tariffs, taxes, laws and regulations, crating, timing, etc., are to comply with the program timing.

Task 8.3 relates to completing Facility Modifications. This task includes completing facility modifications to meet the requirements of the Ford Production System and the program's objectives.

Task 8.4 relates to beginning Production Tool Verification at Final Production Location. This task includes following the installation of the production tools at the final production location, a tryout of the tools will be required to verify all functional aspects as well as compliance to the specifications. This tryout is intended to prove-out and debug the tool design and build for interferences, interfaces to other equipment, interlocks, sequence, feasibility, unforeseen product/tooling concerns, etc., at the final production location. The number of cycles/hits/loads required to prove-out the design and build intent is to be identified in the specification to satisfy the buy-off requirements.

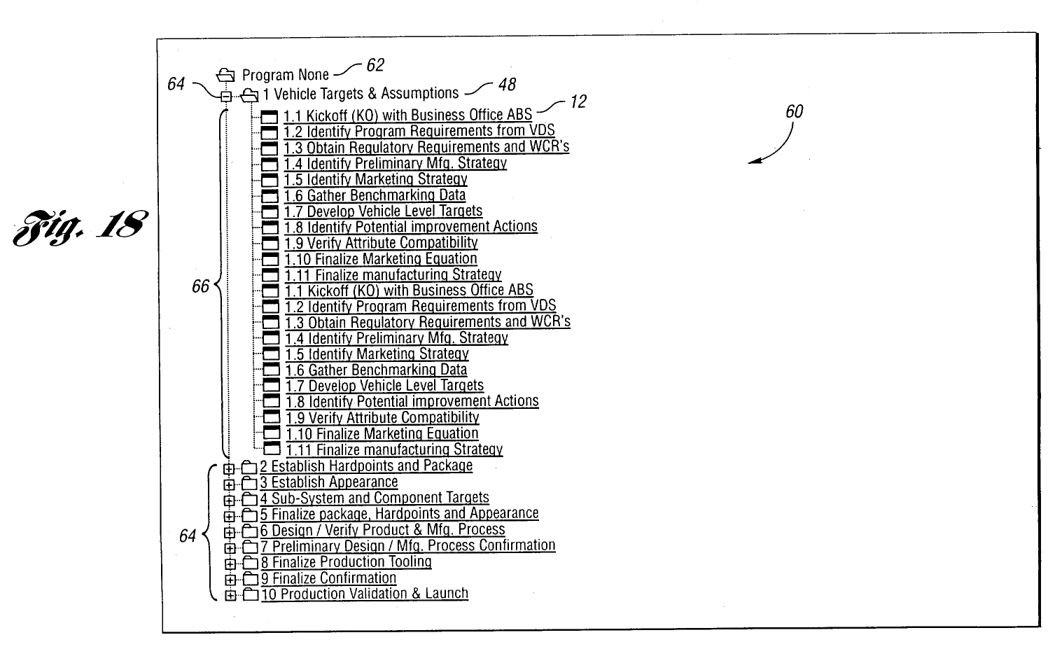

FIG. 16 illustrates the tasks grouped within module #9 for finalizing Confirmation. The objective of this module is to achieve a final engineering sign off and Part Submission Workout (PSW) parts production. The final engineering sign off is accomplished through certification, homologation and final calibration testing. PSW includes a Hard Tooled Function Build at the final assembly plant. Powertrain production validation is also initiated in this module utilizing the production intent calibration along with PSW parts.

Task 9.1 relates to CP Vehicle & Lab/Rig Certification/Homologation Testing. This task includes vehicle and lab/rig certification/homologation tests are run at the end-item/component, subsystem, and system levels as outlined in the DVP to certify the design meets the required government requirements. Test fixtures are designed and manufactured to accomplish the certification/homologation test.

Task 9.2 relates to preparing Certification/Homologation Documents. This task includes certifying documents that are prepared for all markets and various government agencies for approval to sell vehicles.

Task 9.3 relates to consolidating Final Engineering Sign off Documents. This task includes the final engineering sign-off that is an event that assesses the state of the vehicle program at Launch Readiness and all documentation is prepared to provide the appropriate status on the deliverables.

Task 9.4 relates to finalizing In-Vehicle Calibration Test. This task includes conducting final OBD-II calibration (represents final EEC code for production release).

Task 9.5 relates to completing Facilities and Production Tool Installation/Verification. This task includes re-certifying all existing tools and equipment using carry over parts. In addition, the tasks also include completing shipping and installing the production tooling. Further, the tasks include tryout of all new and modified manufacturing facilities, tooling, equipment, gages, and material handling systems to ensure all manufacturing and production systems can produce at launch. Also, the tasks include performing a preliminary method capability study (PPK).

Task 9.6 relates to producing Part Submission Warrant (PSW) Parts. This task includes producing parts and assemblies for Part Submission Warrant (PSW) using production operators, tools/equipment/machines/gauges/processes/materials under production conditions such as: line speed/feeds/cycle times, levels of automation, tool/die changes, pressures, temperatures, to produce sample parts required to validate the method. Parts/assemblies for PSW approval are to be taken from a typical build that is; a significant production run to represent normal production, from one hour to one shift's production (dependent on line speeds/volumes), and produces a minimum quantity of 300 total parts/assemblies (unless agreed to by the Program Team). Certified Quality Control gauges/checking fixtures/equipment which have passed the gauge repeatability and reliability (R&R) studies are to be used to measure the manufacturing method capability of the parts/assemblies produced.

Task 9.7 relates to performing Hard Tool Functional Build. This task includes the Hard Tooled Functional Build (HTFB) that is an early manufacturing/assembly training build phase at the final production plant, using 100% hard-tooled parts (dimensionally correct—first shots), to finalize assembly feasibility and functionality.

Task 9.8 relates to starting Production Validation for Powertrain (PVP). This task includes this method which starts with the receipt of PSW castings/forging/rough parts ready to be processed through the fully capable production method equipment (at a minimum the production pilot line is required). Complete method capability (as opposed to machine capability) is established and components for PV testing are machined, inspected, assembled and tested at method cycle times (feeds and speeds) and full production volumes. The plant floor personnel training requirements are complete. This method also includes the completion of Product and Method Validation testing and culminates with the successful sign-off of the product and method capability, and full Government certification, thereby making the production plant fully Launch Ready.

FIG. 17 illustrates the tasks grouped within module #10 for producing Validation and Launch. The objective of this module is to achieve production validation at the final production facility though a series of builds, completed government certification and powertrain ramp-up to support vehicle production.

Task 10.1 relates to-completing Powertrain Production Validation. This task includes completing the powertrain production validation method as described in task 9.8.

Task 10.2 relates to Powertrain Launch. This task includes a method that covers the powertrain production plant launch of the new product to support the Vehicle Operation Assembly plant ramp-up curve and system/pipeline fill. All of these subassemblies (i.e., Engine, Transmission . . . ) will be fully salable units (as any government certification requirements would be completed).

Task 10.3 relates to completing 4K Emissions Certification and Fuel Economy Testing. This task includes vehicle Environmental Engineering (VEE) that conducts final certification of the production intent powertrain calibration. This provides data for submission to government agencies for emissions certification. Concurrently complete the mandatory fuel economy testing that was not performed during FEDV and 4K emissions certification testing and obtain approval of the values from the appropriate government agency.

Task 10.4 relates to filing for a Government Certification. This task includes vehicle Environmental Engineering (VEE) which submits the required documentation to EPA and California Resources Board to receive certification.

Task 10.5 relates to releasing Final Calibration. This task includes processing and accomplishes official notification that the powertrain calibration is released for production. The EEC PCM part number is validated and the calibration ok for use in production. VO Pre-production notified of certification compliance and broadcast to assembly plant.

Task 10.6 relates to validating Production. This task includes the First Production Prove-Out (1PP) phases is the early manufacturing/assembly builds at the final production location(s), using 100% hard-tooled PSW parts, to finalize assembly feasibility and functionality in the production tools and equipment.

Task 10.7 relates to validating Production. This task includes field Evaluation Units (FEUs) that will be produced for the purpose of verifying the vehicle functionality by “on-road” driving. A course and driving distance is defined to establish a standard reference for the evaluation, which is intended to reflect typical customer driving conditions.

Task 10.8 relates to validating Production via Continuous/Integrated Build. This task includes the Continuous Sales build of the new model continues confirming the compatibility of the method, production tooling, and all PSW parts for production prove-out. The Integrated Sales build of the new model continues confirming the compatibility of the method, production tooling, and all PSW parts for production proved-out support of the decision to Balance-Out the “old model” and perform final Changeover. Predetermined numbers of salable units are built per day on the assembly line with the previous model. This is the start of the new model ramp-up and continued operator training. At the end of this build phase, an Assembly Plant Readiness meeting will be held with the Launch Team and senior management as defined in the VO-New Models Programs QOS to confirm approval to proceed to the next build phase. The Assembly Plant Readiness review will assess the inputs, and audit-along with reviewing the readiness of the assembly plant for such items as tooling, manpower, quality, and production support systems that are necessary to ensure all assembly objectives for the vehicle build will be met.

Task 10.9 relates to completing all Installation and Verification of Material Handling, Quality, Assembly Systems/Tools. This task includes completing the installation of the material handling, quality systems and assembly tools and equipment at the final production location. In addition, this task also includes completing the tryout of the material handling, quality systems, assembly tooling and equipment. This is required to verify all functional aspects as well as compliance to the specifications. This tryout is intended to prove-out and debug the systems/tools design and build (mechanical/electrical) for interferences, interfaces to other equipment, interlocks, sequence, feasibility, unforeseen product/tooling concerns, etc., at the final production location. The number of cycles/hits/loads required to prove-out the design and build intent is to be identified in the specification to satisfy the buy-off requirements.

Task 10.10 relates to declaring vehicle launch. This task includes, once the system is filled, production of the new model begun, the acceleration plan implemented and 5 to 7 days after the completion of the new models audit, a plant and launch manager review meeting (reference plant and launch manager review method) is conducted with the intent to declare vehicle launch and receive “ok to ship” authorization. Meeting participants are typically the same as for a plant and launch manager review but must also include the appropriate level of management (or their designate) to sign the request to release for ship document and “ok to ship” authorization letters. At this meeting, there is a review of the program, quality indicators, product concerns, plant readiness-indicators, assessment, engineering and supplier readiness. Containment plans are required for any concern, which may affect the customer. Based on the review of this information, a decision is made regarding authorization to release vehicles for shipment to the customer. Ok to ship indicates that the product is ready for the customer. The actual shipping of vehicles will start after confirmation that any containment actions result in acceptable quality levels. Once the assembly plant regional managers approval to release vehicles for shipment is received, the vehicle launch is declared and vehicles are shipped from the assembly plant to the dealers.

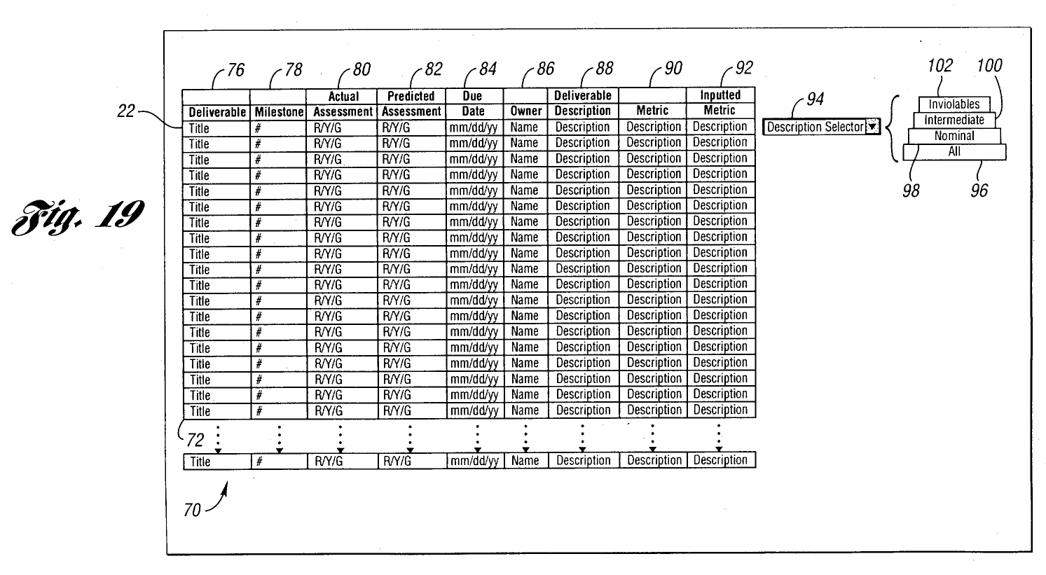

FIG. 18 illustrates a file folder media viewer 60 in accordance with one aspect of the present invention. The file folder media viewer is configured to display the modules 48 in a folder system for a named program 12. The folder system is arranged such that each module corresponds with a selectable folder 66 and each task corresponds with a selectable sub-folder therein. The deliverables, the metrics, the assessment ratings, and the projected assessment ratings are inputted by selecting the folder and then selecting the sub-folder with the desired task.

The file folder media viewer is advantageous for use with computers that are not capable of visually presenting the flowchart view described above.

FIG. 19 illustrates a deliverable media viewer 70. The deliverable media viewer is configured to display each inputted or desired to input deliverable 34 required for product development. As some of the above-identified tasks include multiple deliverables, the total number deliverables can be as much or more than one hundred sixty-five. The deliverable viewer 70 presents each deliverable to the product developer in the form of a status report 72.

The status report 72 includes a heading for deliverable title 76, the milestone for the module that the deliverable 78 corresponds with, the inputted actual 80 and predicted assessment ratings 82, the due date, an owner 84, the deliverable description 86, the metric description 88, the metric description 90 and the inputted metric 92. The product developer can easily view each deliverable without having to select the deliverable as described above using a module and then selecting a task and then finally selecting the deliverable. As such, at any point in product development the product developer can access the computer-readable medium 16 to review all the information inputted thus far. This is helpful in monitoring product development.

As the number of deliverables 34 is rather great, the deliverables viewer can be configured with a deliverables selector 94. The deliverables selector allows the product developer to filter the deliverables according to predefined management preferences. More specifically, the selector allows the product developer to view all the deliverables 96, a nominal number of deliverables 98, an intermediate number of deliverables 100, and a critical number of deliverables 102.

The different number of presented deliverables allows the product developer to monitor product development at different levels.

If the product developer would like to have a detailed view of the current status of product development but desires to eliminate some of the less essential deliverables, the product developer can select the nominal number of deliverables 98. While all the deliverables are needed, the nominal deliverables relate to those deliverables that are slightly more important the all of the deliverables because they may reference typically problematic deliverables.

If the product developer prefers a less detailed view of the deliverables that a slightly more essential than the nominal deliverables 98, then product developer selects the intermediate number of deliverables 100. If the product developer prefers to see the minimum of deliverables and the most essential or inviolable deliverables, the product developer selects the critical number of deliverables 102.

While the best mode for carrying out the invention has been described in detail, those familiar with the art to which this invention relates will recognize various alternative designs and embodiments for practicing the invention as defined by the following claims.

What is claimed:

1. A method for making a product, the method comprising:
determining a number of tasks to complete for making the product, wherein each task includes a start date and a due date that together define a task completion time as a time interval from the start date to the due date;
arranging the tasks for completion according to finish-to-start relationships, wherein the finish-to-start relationship of the tasks allow for the completion time of a predeceasing task to be decreased without increasing the completion time of a subsequent related task;
recording a product development schedule from the arranged tasks; and
performing the number of tasks according to the schedule to make the product, wherein performance of a subsequent task starts only after the related predecessing task is completed.

2. The method of claim 1 wherein the tasks are for making a refresh change to an automobile and relate to establishing vehicle targets and assumptions, establishing hardpoints and packaging, establishing appearance, establishing subsystem and component targets, finalizing package hardpoints and appearance, designing and verifying product manufacturing methods, confirming preliminary design and manufacturing methods, finalizing production tooling, establishing final confirmation, and conducting production validation.

3. The method of claim 1 further comprising determining a deliverable for each task and recording a deliverable description in the product development schedule for each task, wherein the deliverables are required before completion of each task and for use in completing related subsequent tasks.

4. The method of claim 3 further comprising determining a metric for each deliverable and recording a metric deliverable in the product development schedule for each deliverable, wherein the metrics are required before completion of each deliverable and for use in completing related subsequent tasks.

5. The method of claim 4 further comprising storing the schedule on a computer-readable medium, wherein the computer-readable medium is remotely accessible with a media viewer for use in inputting the deliverables and the metrics for use by the related subsequent tasks and for monitoring the making of the product.

6. The method of claim 5 further comprising inputting an actual assessment rating and a predicted assessment rating for each deliverable to the computer-readable medium, wherein the assessment ratings are for use in adjusting the recorded product development schedule.

7. A system for making a product, the system comprising:
a number of tasks to complete for making the product, wherein each task includes a start date and a due date that together define a task completion time as a time interval from the start date to the due date, wherein the tasks have finish-to-start relationships to allow for the completion time of a predecessing task to be decreased without increasing the completion time of a subsequent related task; and
a computer for storing the number of tasks in the form of a product development schedule based on the finish-to-start relationship of the tasks for use in performing the number of tasks according to the schedule to make the product, wherein performance of a subsequent task starts only after the related predecessing task is completed.

8. The system of claim 7 wherein the tasks are for making a refresh change to an automobile and relate to establishing vehicle targets and assumptions, establishing hardpoints and packaging, establishing appearance, establishing subsystem and component targets, finalizing package hardpoints and appearance, designing and verifying product manufacturing methods, confirming preliminary design and manufacturing methods, finalizing production tooling, establishing final confirmation, and conducting production validation.

9. The system of claim 7 further comprising a deliverable for each task and a deliverable description in the product development schedule for each task, wherein the deliverables are required before completion of each task and for use in completing related subsequent tasks.

10. The system of claim 9 further comprising a metric for each deliverable and a metric deliverable in the product development schedule for each deliverable, wherein the metrics are required before completion of each deliverable and for use in completing related subsequent tasks.

11. The system of claim 10 computer is remotely accessible with a media viewer for use in inputting the deliverables and the metrics for use by the related subsequent tasks and for monitoring the making of the product.

12. The system of claim 11 further comprising inputting an actual assessment rating and a predicted assessment rating for each deliverable to the computer, wherein the assessment ratings are for use in adjusting the product development schedule.

13. A computer-implemented system for making a product, the system comprising:
a computer-readable medium having a number of product development tasks to complete for making the product, wherein each task includes a due date, a deliverable description, and a metric description, and wherein the tasks are related according to-finish-to-start relationships based on the due dates such that performance of a subsequent task starts only after a related predecessing task is completed; and
at least one media viewer configured to visually display each task, wherein each displayed task is selectable for inputting upon completion of the task a deliverable and a metric for the corresponding deliverable description and metric description, wherein the inputted deliverable and metric are transmitted to the computer-readable medium for use in monitoring the making of the product.

14. The system of claim 13 wherein the media viewer is further configured to group the tasks according to a number of product development milestones and to display the grouped tasks with a number of selectable modules, wherein the modules break down product development for top level viewing of the tasks.

15. The system of claim 14 wherein the number of selectable modules are for making a product for use in a refresh change to an automobile and include a first module for establishing vehicle targets and assumptions, a second module for establishing hardpoints and packaging, a third module for establishing appearance, a fourth module for establishing subsystem and component targets, a fifth module for finalizing package hardpoints and appearance, a sixth module for designing and verifying a product and manufacturing methods, a seventh module for confirming preliminary design and manufacturing methods, an eighth module for finalizing production tooling, a ninth module for establishing final confirmation, and a tenth module for conducting production validation and launch.

16. The system of claim 13 wherein the media viewer is configured for inputting an actual assessment rating and a projected assessment rating for assessing the inputted deliverable with respect to the displayed due date, wherein the inputted actual assessment rating and the inputted projected assessment rating are transmitted to the computer-readable medium for use in adjusting the finish-to-start relationship of the tasks.

17. The system of claim 13 wherein the media viewer is a flowchart media viewer configured to diagrammatically display the modules in a work-flow diagram, wherein each module is selectable and each task is selectable therein for inputting the deliverables, the metrics, the assessment ratings, and the projected assessment ratings.

18. The system of claim 13 wherein the media viewer is a file-folder media viewer configured to display the modules in a folder system, wherein each module corresponds with a selectable folder and each task corresponds with a selectable sub-folder therein for inputting the deliverables, the metrics, the assessment ratings, and the projected assessment ratings.

19. The system of claim 13 further comprising a deliverables media viewer configured for selecting at least one product development milestone and to display a total status report for the deliverables having due dates that correspond with the selected product development milestone, wherein the status report includes the deliverable description, the metric description, the inputted deliverable, the inputted metric, the due date, the inputted actual assessment rating, and the inputted projected assessment rating for use in monitoring the making of the product.

20. The system of claim 13 further comprising an inviolables media viewer configured for selecting at least one product development milestone and to display an inviolables status report for a predetermine set of inviolable deliverables having due dates that correspond with the selected product development milestone, wherein the inviolables status report includes the deliverable description, the metric description, the inputted deliverable, the inputted metric, the due date, the inputted actual assessment rating, and the inputted projected assessment rating for use in monitoring product development.
